(19) United States
(12) Patent Application Publication
(10) Pub. No.: US 2007/0032630 A1
(43) Pub. Date: Feb. 8, 2007

(54) Pi-conjugated molecules

(76) Inventors: Yoav Eichen, Haifa (IL); Gadi Schuster, Tivon (IL); Nir Tessler, Zichron Yaakov (IL); Doron Amihood, Ahuzat Barak (IL); Vadim Zolotariov, Haifa (IL); Shay Tal, Kiryat Motzkin (IL); Vladislav Medvedev, Haifa (IL)

Correspondence Address: NATH & ASSOCIATES, 112 South West Street, Alexandria, VA, 22314, US

(21) Appl. No.: 10/533,122

(22) PCT Filed: Oct. 30, 2003
(86) PCT No.: PCT/IL03/00898

§ 371 Date: Jun. 14, 2006

Related U.S. Application Data
(60) Provisional application No. 60/422,101, filed on Oct. 30, 2002.

(51) Int. Cl. C08G 69/08; C08G 73/00

(52) U.S. Cl. 528/310; 528/315; 528/328; 528/422

(57) ABSTRACT

The invention provides π-conjugated oligomers and polymers The oligomers and polymers may comprise at least two π-conjugated amino acid subunits. The oligomers and polymers may contain one or more π-conjugated amino acid subunits that are optically, electrically or electronically active. The invention also provides optical, electronic and electric devices comprising oligomers and/or polymers having one or more π-conjugated amino acids that are optically, electrically, or electronically active.

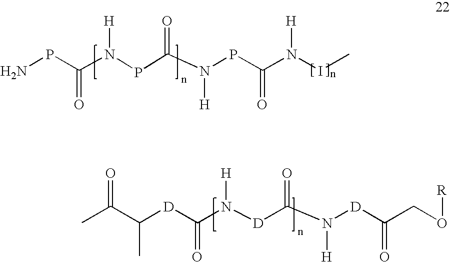

### FIELD OF THE INVENTION

This invention relates to n-conjugated molecules.

### BACKGROUND OF THE INVENTION

π-conjugated polymers have delocalized i-electron bonding along the polymer chain. The π (bonding) and π* (antibonding) orbitals form delocalized valence and conduction wave functions, which support mobile charge carriers.

The following publications provide background to the present application:

Shirakawa, H., Angew. Chem. Int. Ed. 2001, 40, 2574-2580.

MacDiarmid, A. G., Angew. Chem. Int. Ed. 2001, 40, 2581-2590.

Heeger, A. J., Angew. Chem. Int. Ed. 2001, 40, 2591-2611.

Briehn, C. A. and Bauerle, P., Chem. Commun., 2002, 1015-1023.

Friend, R. H., et al., Nature, 397, Jan. 14, 1999.

J. B. Edel et al, Chem. Comm. pp 1136-1137, 2002.

Merrifield, R. B., Biochemistry, 14, 1385, 1964.

Merrifield, R. B., Pure Appl. Chem., 50, 643, 1978.

Merrifield, B. R., Peptides 93-169, 1995.

### SUMMARY OF THE INVENTION

In its first aspect, the invention provides π-conjugated molecules. The π-conjugated molecules of the invention may be oligomers or polymers comprising at least two π-conjugated amino acids. Alternatively, the π-conjugated molecules of the invention may be oligomers or polymers containing one or more π-conjugated amino acids that are optically, electrically or electronically active. The active components may either be embedded in the backbone or skeleton of the molecule, or alternatively be side groups attached to the backbone or skeleton of the molecule.

The oligomers and polymers of the invention preferably contain at least three subunits, more preferably at least four subunits, and still more preferably at least five subunits.

The molecules of the invention may be prepared using solution and/or solid-state methods of coupling amino acids and/or amino acid oligomers, as is known in the art. The π-conjugated peptide molecular structures may be synthesized on a solid support and either cleaved from the support or used bound to the support. The π-conjugated peptide molecular structures may also be synthesized in flow channels as used in “lab-on-a-chip” methods, for example, as disclosed in J. B. Edel et al, Chem. Comm. pp 1136-1137, 2002. The molecular structures of the invention may be linear or branched. The sequence may be random or may also be well defined, as required in any application. The molecules in a population of such structures may all have the same length or there may be a distribution of lengths. The π-conjugated oligomers and polymers may be used as a bulk material, in assemblies of molecules, or as single molecules. The π-conjugated molecular structures of the invention exhibit electrical properties determined by its sequence. The molecular structures may be doped or dedoped to alter their electrical conductivity as required in any application.

The compounds of the invention may be further derivatized with one or more molecular recognition groups that are complementary to specific oligonucleotide or oligopeptide sequences. These materials may be used, for example, as electrically active probes in electrical and/or electronical DNA and RNA chips.

In its second aspect, the invention provides optical, electrical and electronic devices. Such electronic devices include straight and branched wires, resistors, diodes, transistors, photo-sensors, photovoltaic cells and light emitting diodes. The devices of the invention comprise oligomers and polymers having one or more π-conjugated amino acids that are optically, electrically, or electronically active. The active components may either be embedded in the backbone or skeleton of the molecule, or alternatively be side groups attached to the backbone or skeleton of the molecule.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows six exemplary π-conjugated amino acids that may be used in the oligomers and polymers of the invention;

FIG. 2 shows a first scheme for the synthesis of oligomers of the invention;

FIG. 3 shows a second scheme for the synthesis of oligomers of the invention;

FIG. 4 shows a scheme for the synthesis of fmoc protected derivatives of π-conjugated amino acids;

FIG. 5 shows the crystal structure of a π-conjugated dipeptide of the invention;

FIG. 6 shows the absorption spectrum of a π-conjugated amino acid, dipeptide and a tripeptide;

FIG. 7 shows the height of the absorption spectrum peak of a π-conjugated amino acid, dipeptide, and a tripeptide;

FIG. 8 shows the cyclic voltammetry of a π-conjugated amino acid, dipeptide, and a tripeptide;

FIG. 9 shows the i/v curves of a film of a tripeptide of the invention in its pristine and p-doped states (NH₃/I₂);

FIGS. 10a and b show electron conduction in a tripeptide of the invention;

FIG. 11a shows branching subunits, FIG. 11b shows non-conjugated subunits, and FIG. 11c shows non-conjugated subunits having a recognition moiety;

FIG. 12a shows schematically an oligopeptide of the invention that may be used in pn junctions and diodes where P denotes p dopeable segments, I denotes insulating and/or conducting bridging units that may be added to the system and D denotes n-dopeable segments, FIG. 12b shows the structure of PEDOT and FIG. 12c shows the current voltage plot of such the device of FIG. 12a;

FIG. 13 shows a field effect transistor in accordance with the invention;

FIG. 14 shows a photoactive light absorbing π-conjugated amino acid and polypeptide of the invention;

FIG. 15 shows π-conjugated molecules of the invention that are light-emitting and may be used as active layers in an organic light emitting diode of the invention;

FIG. 16 shows the general structure of a “field effect transistor” (FET) of the invention;

FIG. 17 shows two electrically conductive electrodes defined on a substantially nonconductive substrate that is derivatized with an amino functionalized layer in accordance with the invention;

FIG. 18 shows an electronic device having a gate electrode affixed to a substantially non conductive substrate in accordance with the invention;

FIG. 19 shows a field effect transistor in accordance with the invention comprising π-conjugated poly-peptides;

FIG. 20 shows a schematic assembly of a nano-electronic devices in accordance with the invention;

FIG. 21 shows another schematic assembly of a nano-electronic devices in accordance with the invention; and

FIG. 22 shows electrically, electronically and optically active moieties for use as sidegroups.

### DETAILED DESCRIPTION OF THE INVENTION

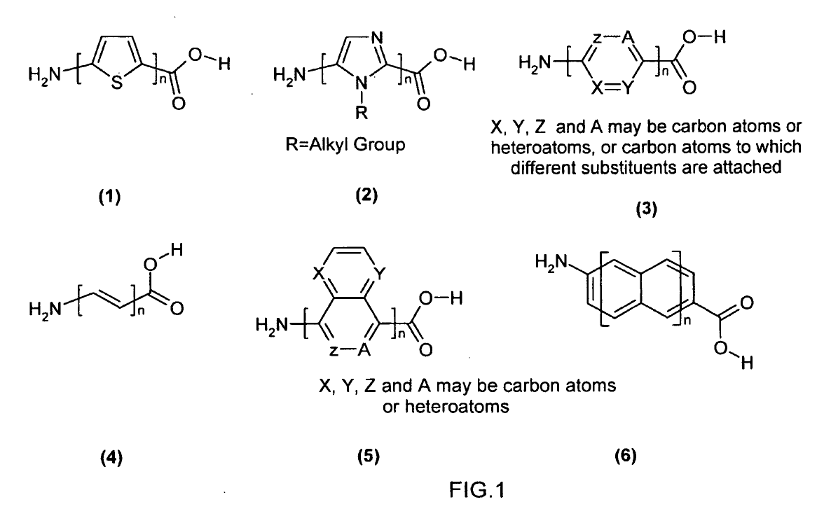

FIG. 1 shows six exemplary π-conjugated amino acids 1, 2, 3, 4, 5, and 6, respectively that may be used in the molecules of the invention. The integer n may be, for example, from 1 to 10. The π-conjugated amino acids shown in FIG. 1 are by way of example only, and any π-conjugated amino acids may be used in the molecules of the invention.

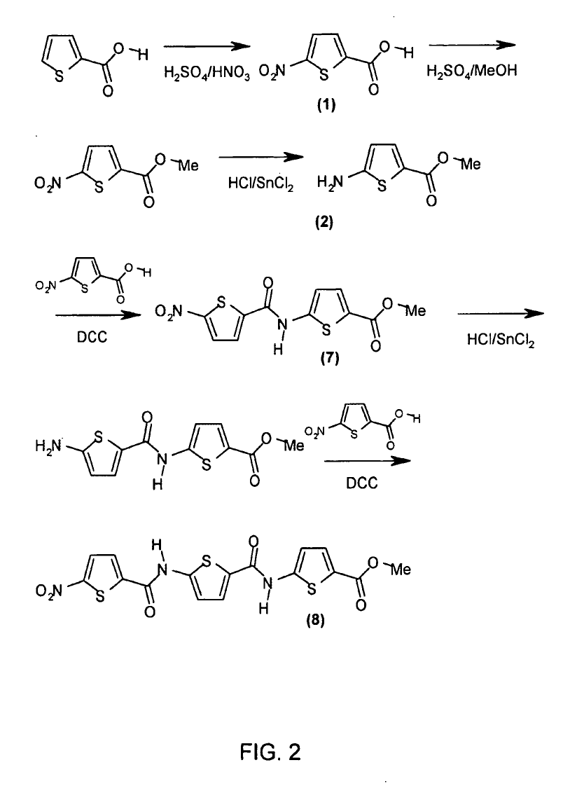

FIG. 2 shows a scheme for the synthesis of oligomers from π-conjugated amino acids of the invention. In the scheme shown in FIG. 2, a dipeptide 7 and a tripeptide 8 are formed from the amino acid monomer 2 shown in FIG. 1 with n=1. This is by way of example, it being obvious to those versed in the art that the scheme of FIG. 2 may be used to synthesize oligomers having any desired combination of π-conjugated amino acids, and having any desired number of amino acid subunits.

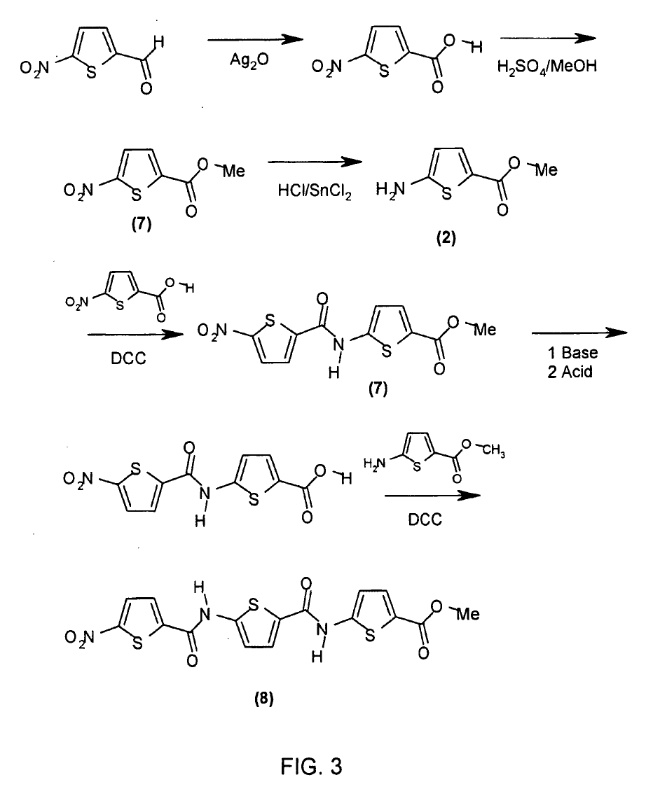

FIG. 3 shows another scheme for the synthesis of oligomers from π-conjugated amino acids of the invention. In the scheme shown in FIG. 3, the dipeptide 7 and the tripeptide 8 (also shown in FIG. 2) are formed from the amino acid monomer 2 shown in FIG. 1 with n=1. This is by way of example, it being obvious to those versed in the art that the scheme of FIG. 2 may be used to synthesize oligomers having any desired combination of π-conjugated amino acids, and any number of amino acid subunits.

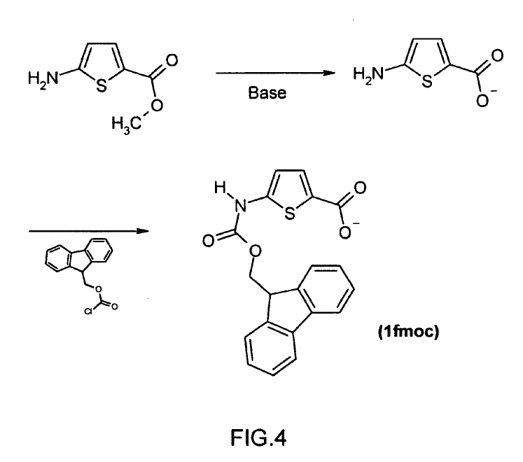

FIG. 4 shows a scheme for the synthesis of fmoc protected derivatives of the π-conjugated amino acids. While FIG. 4 shows synthesis of the fmoc protected derivative of the amino acid 1 shown in FIG. 1 with n=1, this is by way of example only, it being obvious to those versed in the art that the scheme of FIG. 3 may be used to synthesize fmoc protected derivatives of any amino acid. The fmoc protected derivatives may be linked to one another in any desired sequence and length using Merrifield synthesis or other coupling methods known in the art. Alternatively, such oligo and polypeptides of different sequences and lengths may be prepared using alternative methods such as the one described in Merrifield, R. B., Biochemistry, 14, 1385, 1964, Merrifield, R. B., Pure Appl. Chem., 50, 643, 1978, and Merrifield, B. R., Peptides 93-169, 1995.

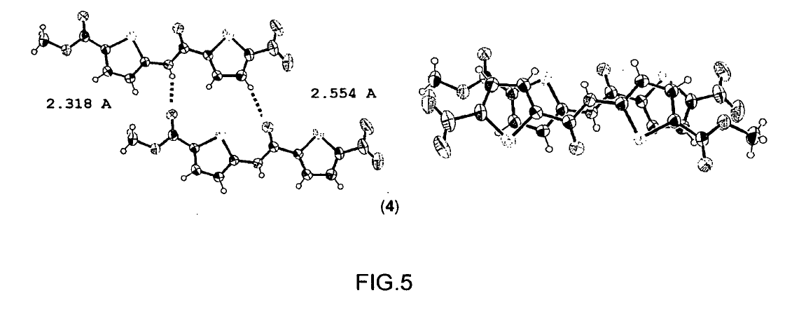

FIG. 5 depicts the crystal structure of the dipeptide 7. The dipeptide 7 crystallizes as a planar β-sheet by relatively short hydrogen bonds. This conformation allows the extended π-conjugation.

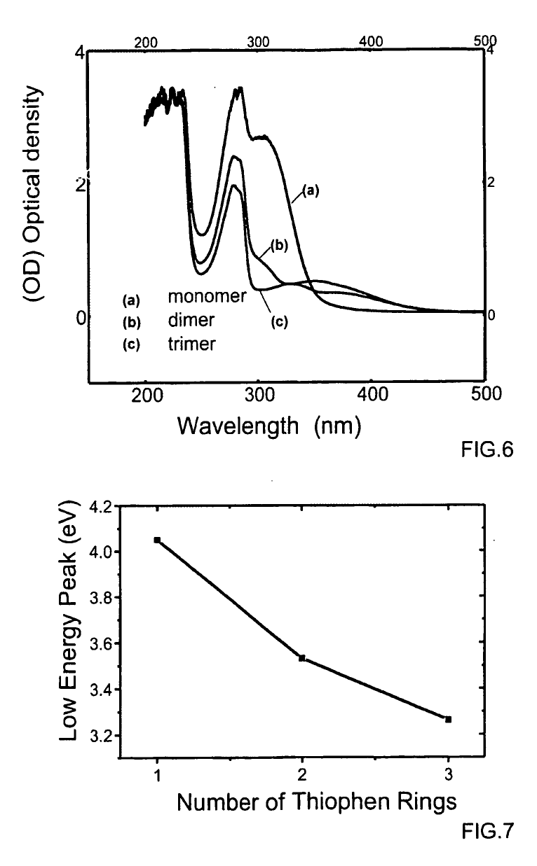

FIG. 6 shows the optical absorption of the monomer 1 (with n=1), the dipeptide 7 and the tripeptide 8. The optical absorption is shifted to the red with increasing length of the π-skeleton. As shown in FIG. 7, the height of the aborption peak decreases with increasing length of the π-skeleton. The results shown in FIGS. 6 and 7 indicate that the molecules of the invention behave similarly to known π-conjugated materials.

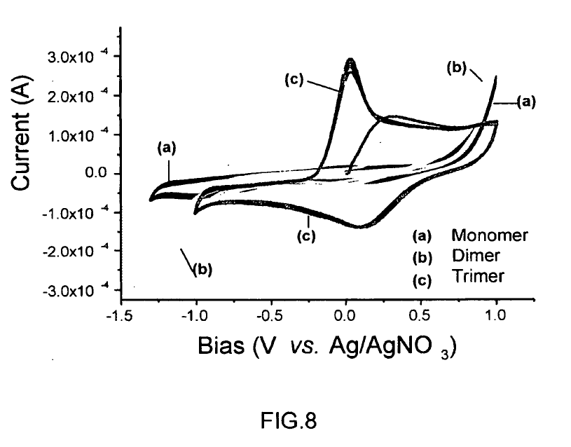

The cyclic voltammetry of compounds 1, 7 and 8 (with n=1) presented in FIG. 8 shows the dependence of the cyclic voltammogram redox waves on the length of the oligomers. The tripeptide 8 surprisingly exhibits a clear and reversible redox process under mild conditions while the didpetide 7 and the monomer 1 are less susceptible to redox processes.

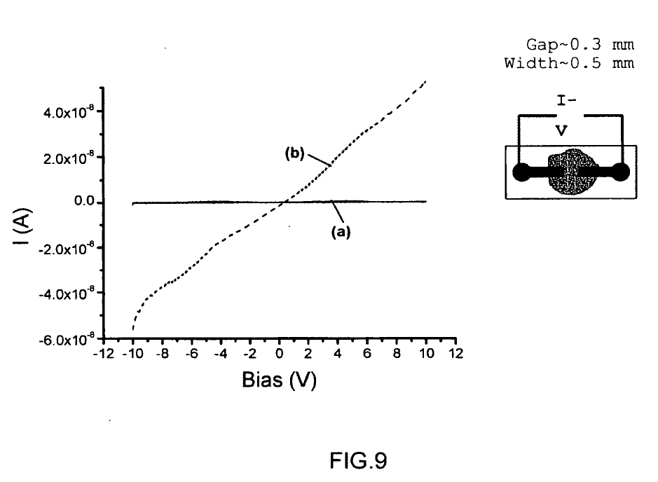

The i/v curves of a film of the tripeptide 8 in its pristine (a) and p-doped (b) states (NH₃/I₂) are shown in FIG. 9. The tripeptide 8 undergoes an efficient p-doping process, rendering it conductive. Similar results were obtained by n-doping of the non-deprotonated system (not shown). The results shown in FIGS. 8 and 9 show that the tripeptide 8 is a π-conjugated material.

### EXAMPLE 1

### A Linear Molecular Wire

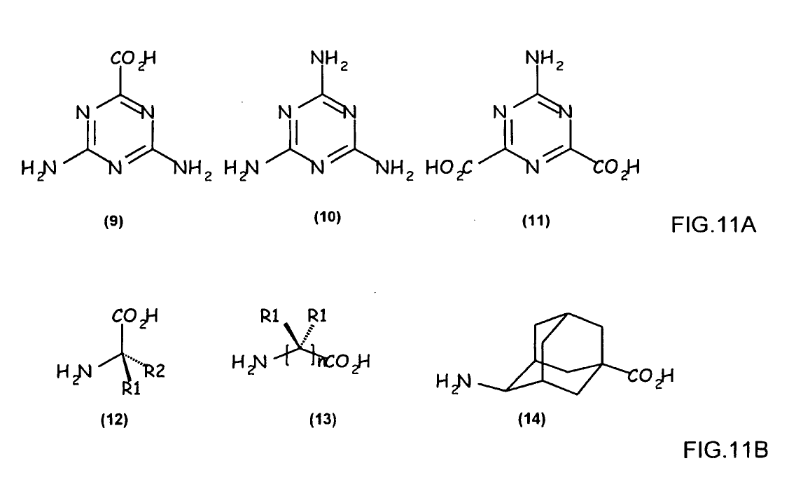

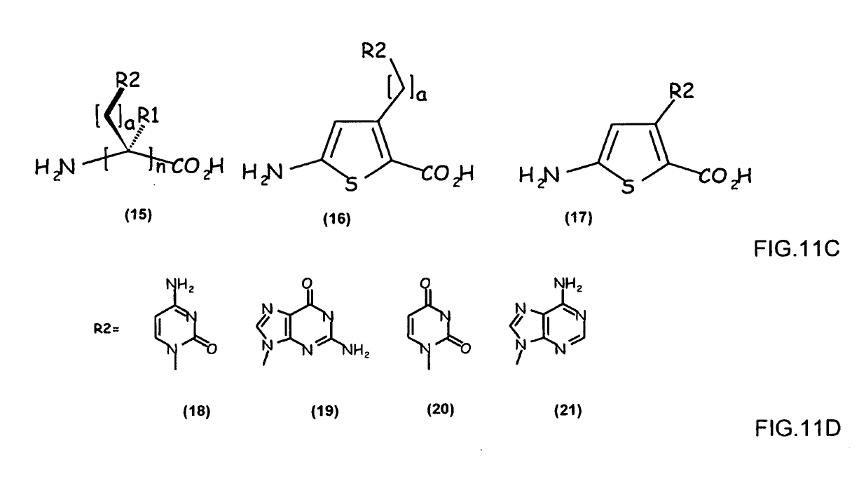

The conductivity of the oligomers and polymers of the invention allow them to be used as molecular wires. The wire may be linear, or may be branched. For the preparation of a branched wire, a π-conjugated peptide molecular structure is prepared and at one or more desired branching points, one or more molecular branching subunits such as the branching subunits 9, 10, and 11 shown in FIG. 11a are introduced to the skeleton. Such molecular fragments allow the branching of the molecular fragment without breaking the π-conjugation.

### EXAMPLE 2

### A Molecular Wire Having One or More Non-Conjugated Segments

A linear or branched π-conjugated peptide molecular structure is prepared and at one or more desired points, one or more non-conjugated subunits such as subunits 12, 13, or 14 shown in FIG. 11b, are introduced to the skeleton, where R1 and R2 can be either identical or different organic residues that endow the molecule with desired properties such as conductive properties, solubility properties, recognition properties. Molecular fragments allow the introduction of electrical barriers of different characteristics into the π-conjugated wire.

### EXAMPLE 3

### A Molecular Wire Bearing One or More Recognition Moieties

A linear or branched π-conjugated peptide molecular structure that may contain one or more nonconjugated segments is prepared and at one or more desired points, one or more conjugated and/or non-conjugated subunits having a recognition moiety, such as subunits 15, 16, and 17 shown in FIG. 11c, in which R2 represents a recognition moiety, are introduced to the skeleton. R2 may be, for example, any of the residues 18, 19, 20, or 21 shown in FIG. 11d or a cyclodextrin, a crown ether, a calixpurrole, biotin, avidin or an antibody. Such molecular wires bind molecules having a binding site complementary to the recognition moiety. Such molecular wires allow recognition of different molecular species, macromolecular species, surfaces etc. In other embodiments of the present invention, wires bearing the recognition moieties may self assemble and/or assemble with other fragments having complementary recognition moieties.

The recognition, binding and self-assembly processes may alter the electrical and/or the optical characteristics of the wires. In some embodiments of the invention, such alterations may be used for the detection of a target species.

### EXAMPLE 4

### A Molecular Resistor

A wire consisting of a linear or branched π-conjugated peptide molecular structure that may contain one or more non-conjugated segments and/or recognition moieties is prepared. The length of the wire and/or the conformation and/or sequence of monomers along it determine its resistance and the resistance of the two- and three-dimensional structures arising from the assembly of such molecular resistors.

### EXAMPLE 5

### A Molecular pn Junction and Diode

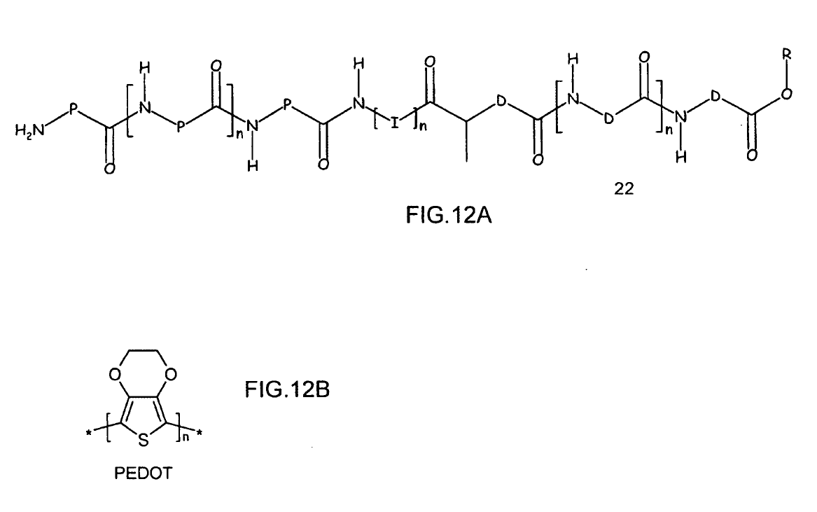

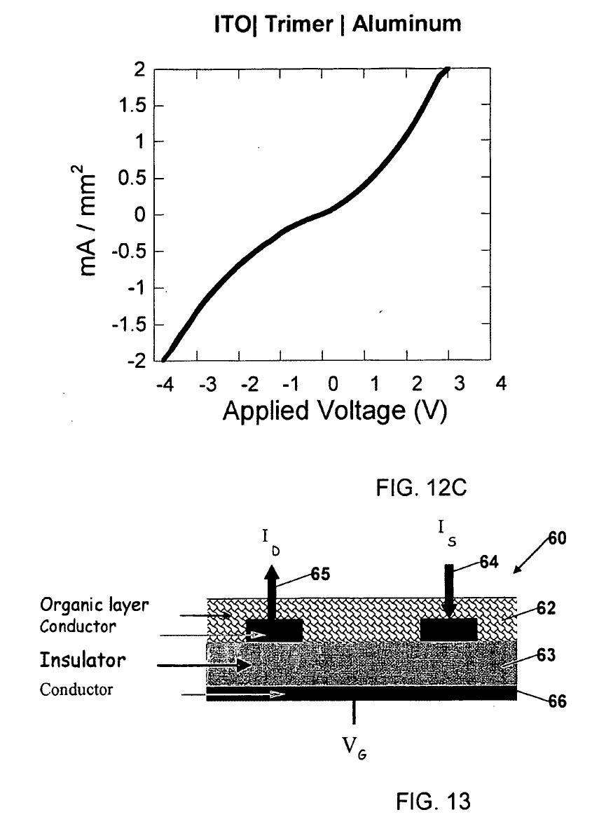

A linear or branched π-conjugated peptide molecular structure possibly containing one or more non-conjugated segments and/or recognition moieties is prepared. FIG. 12a shows schematically an oligopeptide of the invention that may be used in pn junctions and diodes. In FIG. 12a P denotes p dopeable segments, I denotes insulating and/or conducting bridging units that may be added to the system and D denotes n-dopeable segments. The sequence of the monomers consists of a segment of n-dopeable units followed by a segment of a p-dopeable segment. In some embodiments, these two segments may be separated by one or more conductive and/or insulating units for optimizing the properties according to the desired characteristics.

Such a device may be used as an oriented two- or three-dimensional assembly either deposited on or synthesized on a surface. In other embodiments, a single molecule alone serves as the diode or pn junction element.

In another embodiment of the present invention, a diode is made from assemblies of molecules, and n-conjugated peptides are spin cast atop an electrode such as ITO (indium-tin-oxide) or PEDOT (see FIG. 12b). The second electrode is evaporated on top of the active layer, forming the planar diode structure. FIG. 12c shows the current voltage plot of such a device using the tripeptide 8 (See FIG. 2), as the active material. The material is conductive (2 mA/mm² at 3V). In this case, there is very little rectification due to the high charge density in the partially charge-transfer material.

### EXAMPLE 6

### A Field Effect Transistor

FIG. 13 shows a field effect transistor device setup 60 that is constructed using one or more methods known in the art. Linear or branched π-conjugated peptide molecular structures in accordance with the invention are prepared possibly containing one or more non-conjugated segments and/or recognition moieties. The molecular structures are formed into an organic layer 62 by deposition on an insulating surface 63 overlying a conductor 66, or by synthesis between the gap bridging a source lead and a drain lead 65.

The tripeptide 8 was used to prepare a field effect transistor in the bottom contact configuration [see Y. Roichman and N. Tessler, Applied Physics Letters 80, 1948-1950 (2002) which is incorporated here by reference]. The channel length was varied between 2 and 32 μm and the width was fixed at 6000 μm (C_{OX}≈43 nFcm⁻¹, where Cox is the oxide capacitance). The material was spin coated from THF (tetrahydrofurane) solution onto prepared Si/SiO2/Gold substrates. The solution concentration was set so that a final film thickness of about 100 nm was achieved.

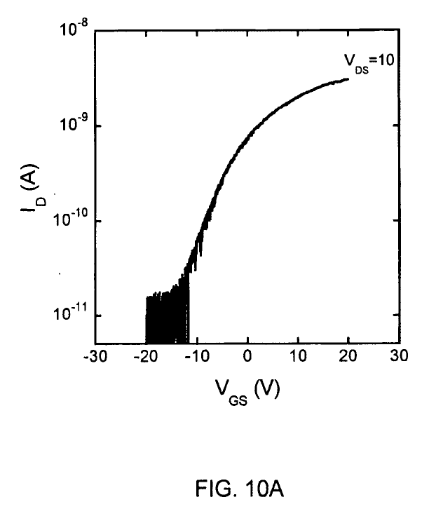

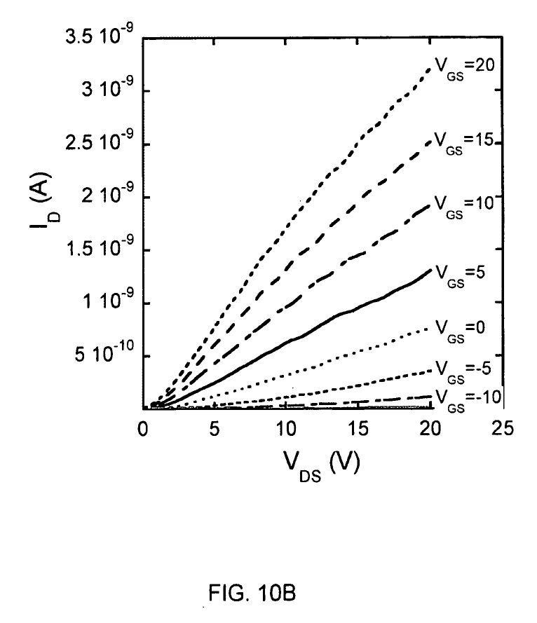

The above structures were tested using a conventional probe station and an HP Hewlet Packard semiconductor parameter analyzer. FIGS. 10a and 10b show the field effect in the transistor. Clearly, the drain-source current is enhanced by the applied gate voltage. The conductive nature of the material is clearly proved. The polarity of the gate bias indicates that this is an electron-based conductance. Analyzing the curve we find that the effective electron mobility is about 10⁻⁷ cm²v⁻¹s⁻¹.

### EXAMPLE 7

### An Organic Photovoltaic Cell and Photosensor

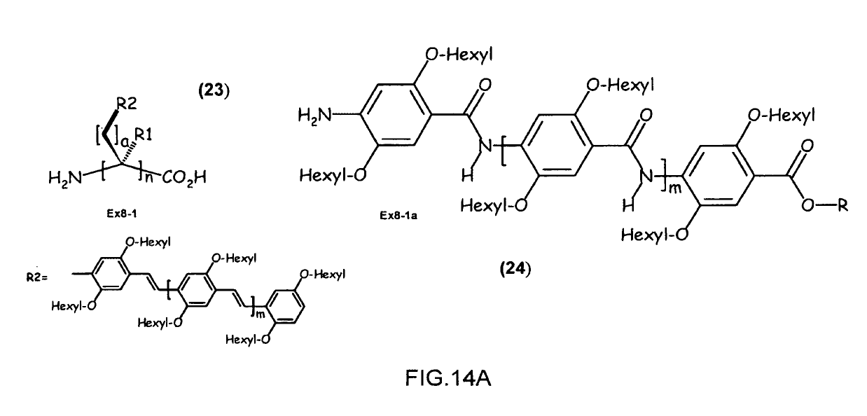

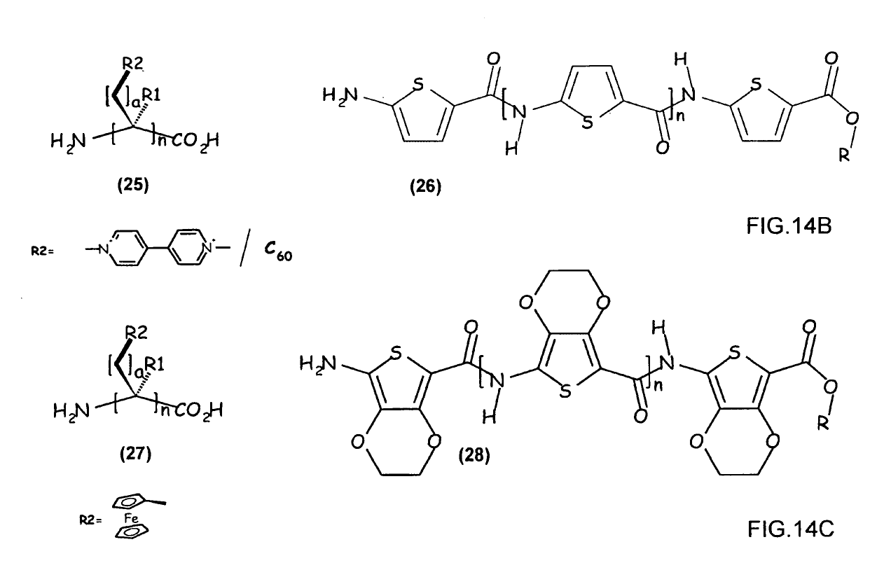

This aspect of the invention utilizes π-conjugated peptides of the invention that are photoreative light absorbing molecules. The peptides may be linear or branched, and possibly contain one or more non-conjugated segments and/or recognition moieties. The peptides are used as a photoactive material in an organic photocell. The active layer consists of at least one photoactive light absorbing molecule and an electron- and/or hole-accepting group. The molecular structure 23 shown in FIG. 14a is an example of a photoactive light absorbing π-conjugated amino acid, and structure 24 is π-conjugated photoactive light-absorbing polypeptide in accordance with the invention formed by polymerization of the polypeptide 23. The structures 25 and 26 shown in FIG. 14b are examples of electron accepting groups, and the structures 27 and 28 are examples of a hole accepting groups.

The active organic medium may consist of the photoactive compound alone, a solid solution and/or a mixture of the photoactive material and one or more of the electron active components, or molecular species consisting of any combination of the three. The peptide may consist solely of conjugated segments, or may be a combination of π-conjugated and non-conjugated segments.

### EXAMPLE 8

### A Light Emitting Diode

A linear or branched π-conjugated peptide molecular structure possibly containing one or more non-conjugated segments and/or recognition moieties is prepared that serves as a light emitting material in an organic light emitting diode. Molecular structures 25, 26, 27, and 28 shown in FIG. 15, where R1 is any organic residue, are examples of molecules of the invention that are light-emitting and may be used as active layers in the organic light emitting diode.

The active organic medium is placed on a transparent electrode by means of spin coating or blade casting. The second electrode is placed on the active material using vapor deposition.

### EXAMPLE 9

### A DNA Chip

A π-conjugated poly nucleic acid (PNA) or a hybrid molecule composed of a π-conjugated peptide and a nucleic acid skeleton may be incorporated it into a field effect transistor device In order to detect changes in the electronic properties of a compound of the invention upon hybridization to a DNA fragment of a specific sequence.

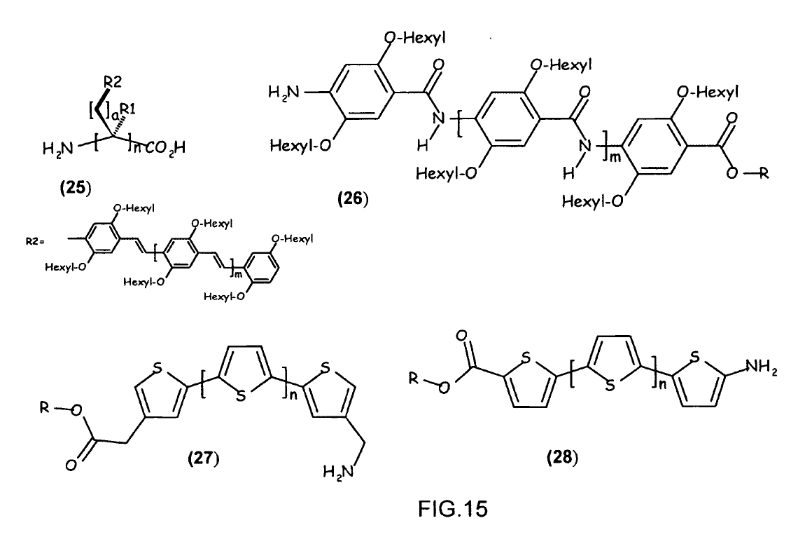

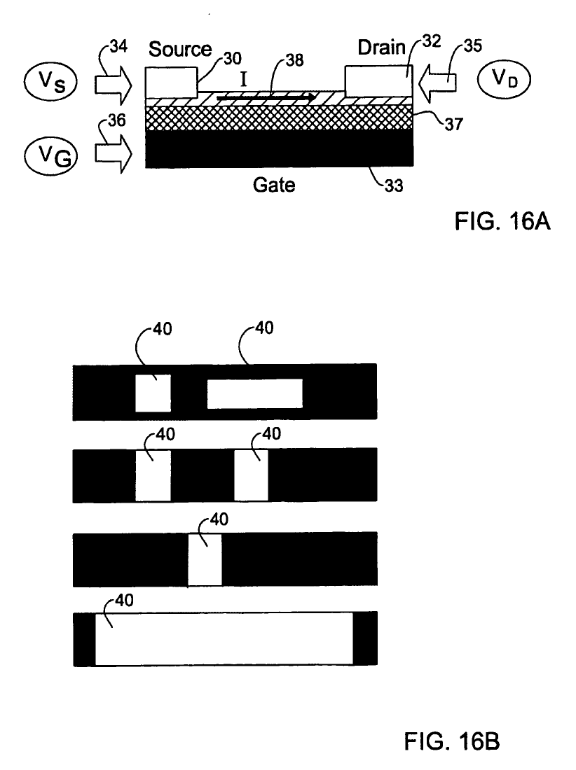

The general structure of a device for carrying out the method, referred to as a “field effect transistor” (FET) is shown in FIG. 16a. The FET is a three-electrode device where current flows between a source electrode 31 and a drain electrode 32. The amount of current that flows between the electrodes is controlled by a gate electrode 33 that is separated from the source and drain electrodes by an essentially non-conductive gap 37. A current carrier 38, which is typically a semiconducting material, is placed atop the non-condive gap 37, between the source and the drain electrodes. To operate this device an external voltage/current source is connected through appropriate leads 34, 35, 36. In order to detect a hybridization event, the transistor may be designed so that the hybridization occurs in layer 38, thus affecting the DC conductivity of the device. Alternatively, the hybridization site may be located at any of the electronically important elements 31, 32, 33, 34, 35, and 36. Time varying signals may be used to improve device sensitivity. The hybridization site span may occupy the entire space allocated for a specific element or constitute only part of it. The hybridization site may break the space into sub-units or simply occupy part of the space, forming a shape that is most suitable for the specific application. FIG. 16b depicts some examples for the incorporation of a binding (hybridization) site into any of the electronic elements constituting the FET. Squares denoted as 40 are the hybridization sites.

### EXAMPLE 10

### A DNA/RNA Chip Based on Induced Changes in Electrical Conductivity Upon Hybridization of DNA/RNA with Surface-Bound π-Conjugated PNAs

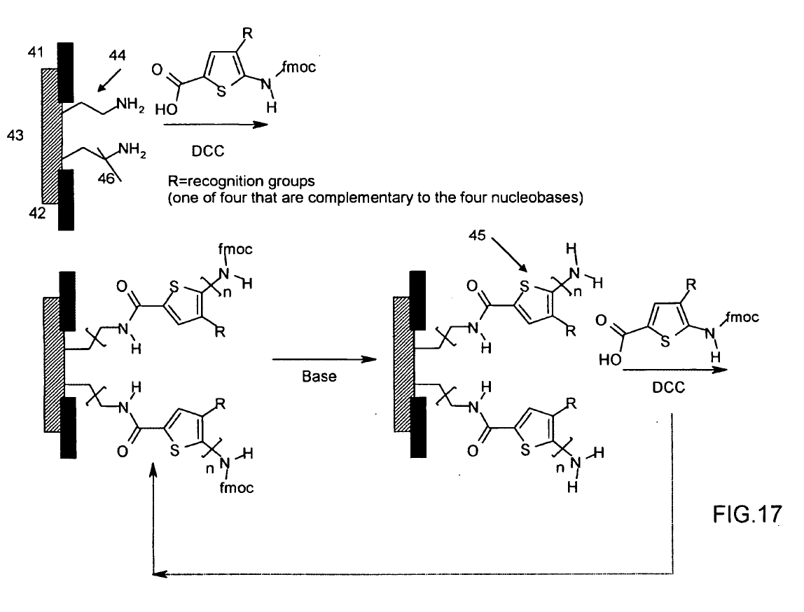

As shown in FIG. 17, two electrically conductive electrodes 41 and 42 are defined on a substantially nonconductive substrate 43 that is derivatized with an amino functionallized layer 44. A layer of a specific sequence of a π-conjugated PNA 45 is grown in the gap 46 between the two electrodes using solid-state synthesis procedures. By choosing the specific sequence of the R groups a specific probe can be tailored for different nucleic acid analytes to be detected. The device is then dried and the electrical conductivity between the two electrodes is measured. Changes in the electrical characteristics, such as conductance, of the device are correlated to the amount of analyte bound to the gap.

Upon contacting a solution that may contain the analyte to be detected with the device and applying appropriate PNA-DNA or PNA-RNA hybridization conditions, any hybridization between the surface-bound probe and the analyte occurs on the surface is detected by a change in the conductivity between the electrodes 42. The device may be washed by applying different stringency lo conditions in order to remove non-specifically bound nucleic acids.

### EXAMPLE 11

### A DNA/RNA Chip Based on Modification of the Charge Transport Properties in Field Effect Transistors Upon Hybridization of DNA/RNA with Surface-Bound π-Conjugated PNAs

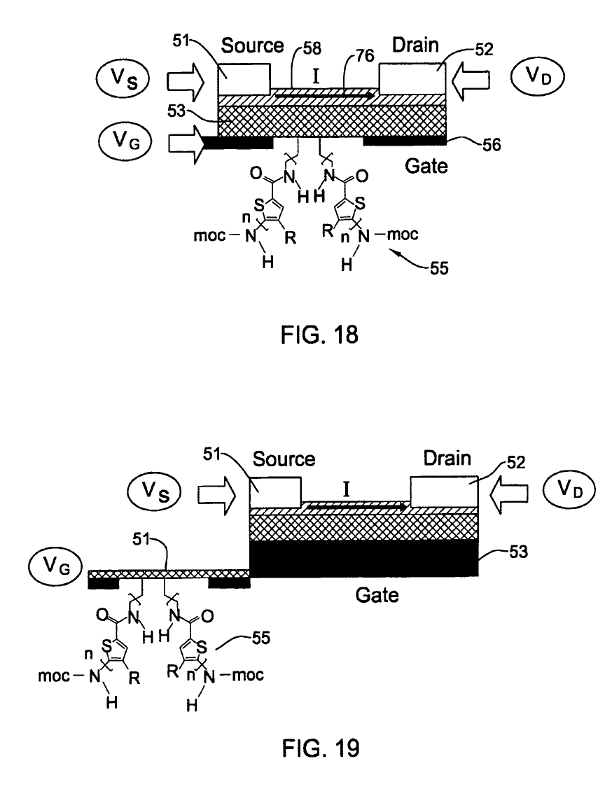

As shown in FIG. 18, a device may be used as in Example 10 where a gate electrode 56 is affixed to a substantially non conductive substrate 53. The conductivity between the electrodes 51 and 52 is modified by the presence of analyte molecules that are bound to the probes 55 such that a channel 58 between the electrodes 51 and 52 is charged faster or slower, thus affecting the turn on characteristics, as turn-on/off times or magnitudes (to be tested in AC and/or DC modes). Since the DNA/RNA molecules are polar, an enhancement of the threshold voltage also occurs.

### EXAMPLE 12

### A DNA/RNA Chip Based on Modification of the Charge Transport Properties in a Field Effect Transistor Upon Hybridization of DNA/RNA with Surface-Bound π-Conjugated PNAs that Form the Gate Electrode

FIG. 19 shows a field effect transistor 3-1 [The figure has to be labeld with numbers.] comprising π-conjugated poly-peptide of the invention. A gate 3-2 is composed of a substantially non-conductive layer 3-3 that is derivatized with an amino functionallized layer 3-4 and a side contact 3-5. A layer of a specific sequence of a π-conjugated PNA 3-6 is grown from layer 3-4 using solid-state synthesis procedures such as the one depicted in FIG. 19 (a schematic description of the hybridization zone being part of the gate electrode current/voltage path). By choosing the specific sequence of the R groups one can tailor a specific probe for different nucleic acid analytes to be detected. The conductivity across the gate electrodes is enhanced, thus allowing for the applied potential to propagate faster across the gate, modulating the charge density at the channel.

### EXAMPLE 13

### A General Sensory Chip Based on a Modification of Examples 10a to 10c

Other preferred embodiments of the invention consist of a slight modification of Examples 9 to 12 in which the PNA skeleton is replaced by a p-conjugated oligomeric structure bearing different recognition groups, tailored to bind specific and non specific molecular and/or non molecular targets.

Examples 9 to 13 describe devices that detect biological and chemical recognition processes by means of an altered electrical property of the device. The invention also provides devices that detect biological or chemical recognition processes by means of an altered optical property (for example, the absorption or emission properties) of the device.

### EXAMPLE 14

### Molecular Integrated Circuits Composed of π-Conjugated Peptide Oligomers

Once the basic building blocks (conductor, insulator, semiconductors) are available they can be assembled into complex structures using DNA templating and copying techniques or using Merrifield type synthesis based schemes. In a somewhat similar manner to the standard, micron-scale, devices, one can assemble various device functionalities (such as transistor, optical modulator, optical detector, switches, transmitters) and integrate them into a complex circuit. Using the DNA analogs (peptides, PNAs) one can control the assembly and direct connectivity on the molecular scale.

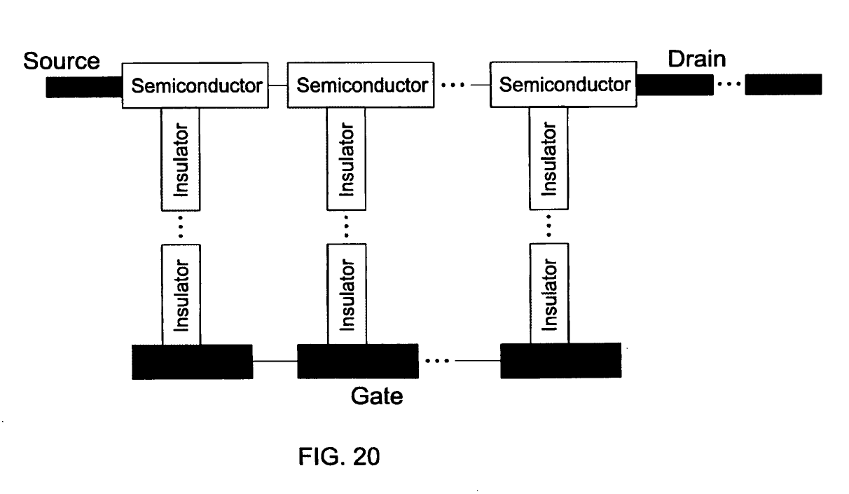

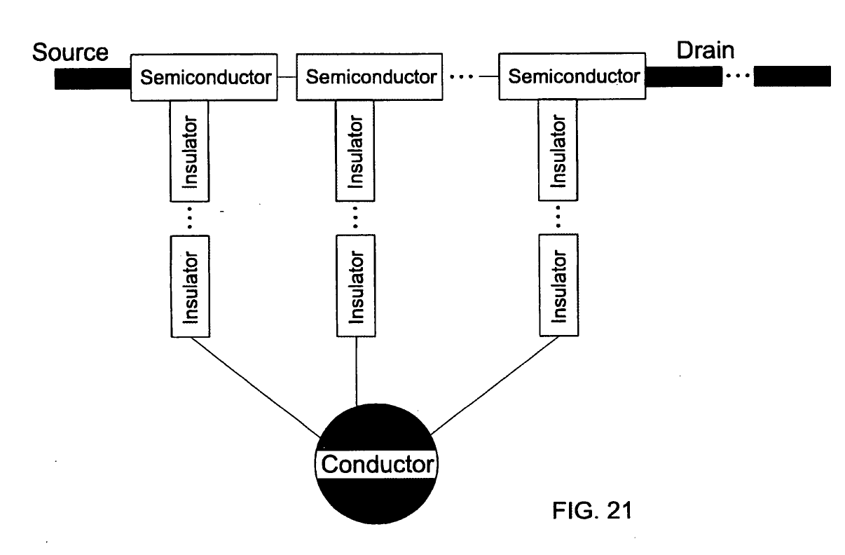

FIG. 20 shows a schematic assembly of a nano-electronic device. It may be made of single molecules. However, it is more reliable if one or more of the layers (e.g. conductor, insulator, or semiconductor) are made of more then one conjugation unit. Specifically, it is preferable that the number of semiconductor units be larger than 10 and preferably between 30 and 100. For such large numbers the device performance can be tuned by choosing the number of semi-conductor units that have an insulator attached and their position. Generally, some of the functional units can be inorganic particles as dots or preferably wires that are suitably functionalized to render them compatible with DNA/PNA/Peptide assembly methods. FIG. 21 shows the schematic use of single point assembly of connections. The single point could also be an inorganic particle which is functionalized to match the other units.

Examples 1-14 describe various applications of oligomers and polymers that are electrically, electronically, or optically, active, having a partial or complete π-conjugated skeleton, as described, for example in FIGS. 1 and 12. In other preferred embodiments of the invention, similar devices and apparatuses comprise oligomers and/or polymers that are electrically, electronically, or optically, active, in which active moieties are attached as a sidegroups to the skeleton by different synthesis protocols. Oligomers and polymers can be prepared having a specific sequence with randomly attached sidegroups.

Solubilizing groups such as linear or branched hydrocarbons or different functional groups such as the recognition groups shown in FIG. 11D may be added in a specific or non specific order and composition Solubilizing groups may also be introduced to the skeleton either on the nitrogen atom of the peptide bond or as the second substituent at the sp3 carbon or as a sidegroup anywhere else.

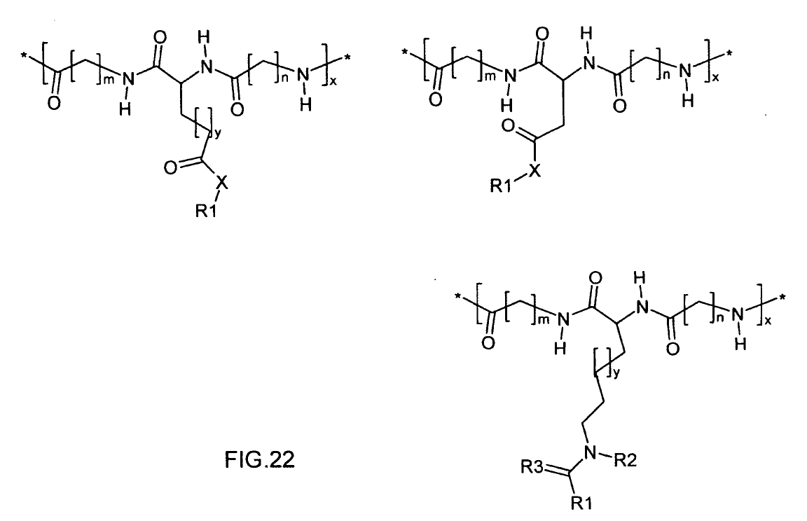

Examples of such molecules are depicted in FIG. 22 where R1 is the optically, electrically or electronically active component, X is an atom of the group O/S/N/P/metal, R2 is an organic substituent or any cation, R3 is an atom of the group O/S/N.

1. An oligomer or polymer selected from the group comprising:
(a) an oligomer or polymer comprising at least two π-conjugated amino acid subunits; and
(b) an oligomer or polymer containing one or more π-conjugated amino acid subunits that are optically, electrically or electronically active.

2. The oligomer or polymer according to claim 1, wherein the oligomer or polymer or oligomer is straight.

3. The oligomer or polymer according to claim 1 wherein the oligomer or polymer is branched.

4. The oligomer or polymer according to claim 1 comprising one or more non-conjugated segments.

5. The oligomer or polymer according to claim 4 comprising one or more non-conjugated segments selected from the group comprising molecular structures 12, 13, or 14:

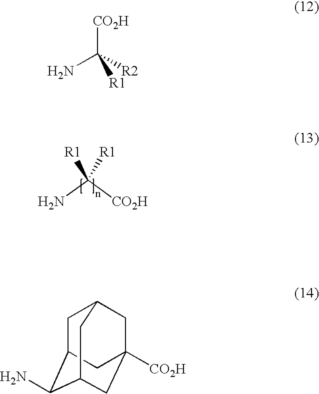

6. The oligomer or polymer according to claim 1 further comprising one or more dopeable segments.

7. The oligomer or polymer according to claim 6 wherein the oligomer or polymer is the molecular structure of FIG. 12a.

8. The oligomer or polymer according to claim 1 comprising one or more photoreactive light absorbing subunits.

9. The oligomer or polymer according to claim 1 comprising one or more light emitting molecules.

10. The oligomer or polymer according to claim 9 selected from the group comprising molecular structures 25, 26, 27, and 28:

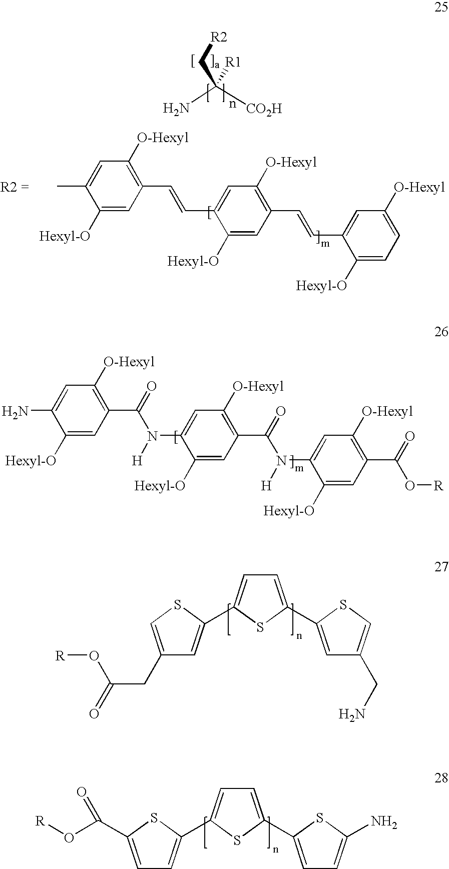

11. The oligomer or polymer according to claim 1 further comprising a recognition moiety.

12. The oligomer or polymer according to claim 1 comprising one or more π-conjugated amino acid subunits that are optically, electrically or electronically active wherein the active subunits are embedded in the skeleton or backbone of the molecule.

13. The oligomer or polymer according to claim 1 comprising one or more π-conjugated amino acid subunits that are optically, electrically or electronically active wherein the active subunits are attached as subunits to the skeleton or backbone of the molecule.

14. An optical, electronic or electric device comprising oligomers and/or polymers having one or more π-conjugated amino acids that are optically, electrically, or electronically active.

15. The device according to claim 14, wherein the oligomer or polymer or oligomer is straight.

16. The device according to claim 14 wherein the oligomer or polymer is branched.

17. The device according to claim 14 wherein the oligomers or polymers comprise one or more non-conjugated segments.

18. The device according to claim 17 wherein the oligomers or polymers comprise one or more non-conjugated segments selected from the group comprising molecular structures 12, 13, or 14:

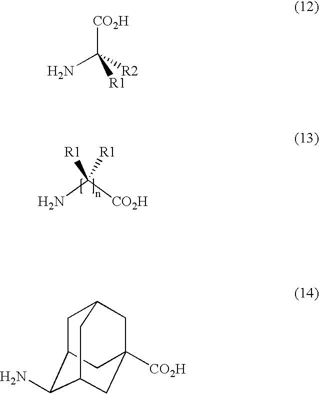

19. The device according to 13 further wherein the oligomers or polymers comprise one or more dopeable segments.

20. The device according to claim 19 wherein the oligomer or polymer is the molecular structure of FIG. 12a.

21. The device according to claim 13 wherein the oligomers or polymers comprise one or more photoreactive light absorbing subunits.

22. The device according to claim 13 wherein the oligomers or polymers comprise one or more light emitting molecules.

23. The device according to claim 22 selected from the group wherein the oligomers or polymers comprise molecular structures 25, 26, 27, and 28.

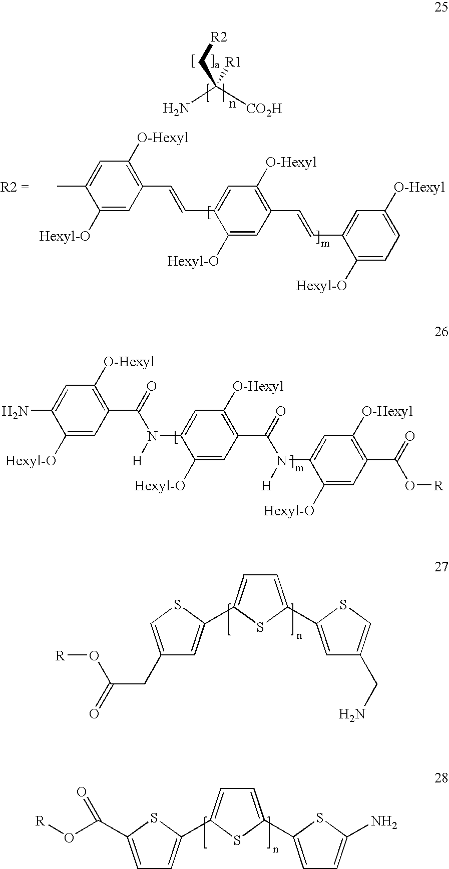

24. The device according to claim 1 further wherein the oligomers or polymers comprise a recognition moiety.

25. The device according to claim 13 wherein the oligomers o/r polymers comprise one or more π-conjugated amino acid subunits that are optically, electrically or electronically active wherein the active subunits are embedded in the skeleton or backbone of the molecule.

26. The device according to claim 13 wherein the oligomers or polymers comprise one or more π-conjugated amino acid subunits that are optically, electrically or electronically active wherein the active subunits are attached as subunits to the skeleton or backbone of the molecule.

27. The electronic device according to claim 13 wherein the device is selected from the group comprising:
(a) a wire;
(b) a resistor;
(c) a diode;
(d) a pn junction;
(e) a transistor;
(f) a field effect transistor;
(g) a photovoltaic cell;
(h) a photosensor;
(i) a light emitting diode;
(j) a DNA chip; and
(k) a sensory chip.
